(19) United States
(12) Patent Application Publication
(10) Pub. No.: US 2026/0051538 A1
(43) Pub. Date: Feb. 19, 2026

(54) ELECTROLYTE COMPOSITION, AND BATTERY AND DEVICE INCLUDING THE ELECTROLYTE COMPOSITION

(71) Applicant: GM GLOBAL TECHNOLOGY OPERATIONS LLC, Detroit, MI (US)

(72) Inventors: Vamakshi Yadav, Sterling Heights, MI (US); Lei Wang, Rochester Hills, MI (US)

(73) Assignee: GM GLOBAL TECHNOLOGY OPERATIONS LLC, Detroit, MI (US)

(21) Appl. No.: 18/802,496

(22) Filed: Aug. 13, 2024

(51) Int. Cl. H01M 10/0567; B60L 50/60; H01M 10/0525; H01M 10/0569; H01M 10/42

(52) U.S. Cl. CPC H01M 10/0567; H01M 10/0525; H01M 10/0569; H01M 10/4235; B60L 50/60; H01M 2220/20; H01M 2300/0037

(57) ABSTRACT

An electrolyte composition for batteries is provided. The electrolyte composition includes a solvent and a partially substituted phosphite additive. The partially substituted phosphite additive is chosen from mono(trimethylsilyl) phosphite, bis(trimethylsilyl) phosphite, a Li salt derivative thereof, or a combination thereof. Additionally, a battery and a device including the electrolyte composition is provided.

### INTRODUCTION

The disclosure generally relates to an electrolyte composition for batteries.

Battery cells may include an anode, a cathode, an electrolyte composition, and a separator. A battery cell may operate in charge mode, receiving electrical energy. A battery cell may operate in discharge mode, providing electrical energy. A battery cell may operate through charge and discharge cycles, where the battery first receives and stores electrical energy and then provides electrical energy to a connected system. In vehicles utilizing electrical energy to provide motive force, battery cells of the vehicle may be charged, and then the vehicle may navigate for a period of time, utilizing the stored electrical energy to generate motive force.

A battery cell includes an electrolyte composition which provides lithium-ion conduction paths between the anode and the cathode. The electrolyte is an ionic conductor. The electrolyte is additionally an electronically insulating material.

One of the factors that determines the commercial viability of a battery cell is its capacity and cycling tolerance. A battery cell(s) for an automotive vehicle with an electric-drive powertrain may be tasked to provide at least 30,000 hours of service. Such high requirements may present a challenge to the vehicle's battery cell(s).

### SUMMARY

An electrolyte composition for batteries in accordance with one or more embodiments is provided. The electrolyte composition includes a solvent and a partially substituted phosphite additive. The partially substituted phosphite additive is chosen from mono(trimethylsilyl) phosphite, bis(trimethylsilyl) phosphite, a Li salt derivative thereof, or a combination thereof.

In some embodiments, the Li salt derivative thereof is lithium bis(trimethylsilyl) phosphate.

In some embodiments, the partially substituted phosphite additive is bis(trimethylsilyl) phosphite.

In some embodiments, the partially substituted phosphite additive is present in an amount of from about 0.1 to about 5 wt. %, based on a total weight of the electrolyte composition.

In some embodiments, the partially substituted phosphite additive is present in an amount of from about 1 to about 5 wt. %, based on a total weight of the electrolyte composition.

In some embodiments, the partially substituted phosphite additive is present in an amount of from about 2 to about 4 wt. %, based on a total weight of the electrolyte composition.

In some embodiments, the electrolyte composition further includes co-additives.

In some embodiments, the co-additives include one or more lithium-based compounds chosen from LiPO₂F₂, LiTFSI, LiFSI, LiDFOB, LiBOB. or a combination thereof.

In some embodiments, the one or more lithium-based compounds is present in an amount of from about 0.1 to about 2 wt. %, based on a total weight of the electrolyte composition.

In some embodiments, the co-additives includes one or more phosphorous-and silicon-based additives chosen from tris(trimethylsilyl) phosphite, tris(trimethylsilyl) phosphate, or a combination thereof.

In some embodiments, the one or more phosphorous-and silicon-based additives is present in an amount of from about 0.1 to about 2 wt. %, based on a total weight of the electrolyte composition.

In some embodiments, the solvent is chosen from fluoroethylene carbonate, dimethyl carbonate, ethylene carbonate, ethyl methyl carbonate, dimethyl carbonate, propylene carbonate, 2,2,2-trifluoroethyl methyl carbonate, bis(2,2,2-trifluoroethyl) carbonate, 3,3,3-trifluoropropylene carbonate, or a combination thereof.

A battery in accordance with one or more embodiments is provided. The battery includes an anode and a lithium-and manganese-rich layered oxides (LMR) cathode. An electrolyte composition is disposed between the anode and the LMR cathode. The electrolyte composition includes a solvent and a partially substituted phosphite additive. The partially substituted phosphite additive is chosen from mono(trimethylsilyl) phosphite, bis(trimethylsilyl) phosphite, a Li salt derivative thereof, or a combination thereof.

In some embodiments, the LMR cathode includes comprises LixMnyNiZO₂, wherein x is from 1.1 to 1.5, y is from 0.8 to 0.6, and z is from 0.2 to 0.4.

In some embodiments, the LMR cathode further includes LFMP, LFP, NCMA, NMC, NCA, LNMO, or a combination thereof.

In some embodiments, the anode includes SiOx/graphite, graphite, Si, SiOx, lithium metal, or a combination thereof, and wherein x is a value greater than 0.

In some embodiments, the anode and the LMR cathode have a negative to positive (N/P) ratio of from about 1 to about 3.

In some embodiments, the battery is configured to operate over a voltage window of from about 2.0 to about 5.0 V.

In some embodiments, the battery is configured to be charged at a charging rate of from about C/100 to about 6 C.

A device in accordance with one or more embodiments is provided. The device includes an output component and a battery that is configured for providing electrical energy to the output component. The battery includes an anode and a lithium-and manganese-rich layered oxides (LMR) cathode. An electrolyte composition is disposed between the anode and the LMR cathode. The electrolyte composition includes a solvent that is chosen from fluoroethylene carbonate, dimethyl carbonate, ethylene carbonate, ethyl methyl carbonate, dimethyl carbonate, propylene carbonate, 2,2,2-trifluoroethyl methyl carbonate, bis(2,2,2-trifluoroethyl) carbonate, 3,3,3-trifluoropropylene carbonate, or a combination thereof. The electrolyte composition further includes a partially substituted phosphite additive that is chosen from mono(trimethylsilyl) phosphite, bis(trimethylsilyl) phosphite, a Li salt derivative thereof, or a combination thereof. The partially substituted phosphite additive is present in an amount of from about 0.1 to about 5 wt. %, based on a total weight of the electrolyte composition.

The above features and advantages and other features and advantages of the present disclosure are readily apparent from the following detailed description of the best modes for carrying out the disclosure when taken in connection with the accompanying drawings.

### BRIEF DESCRIPTION OF THE DRAWINGS

FIG. 1 schematically illustrates an exemplary battery cell including an anode, a cathode, a separator, and an electrolyte composition, in accordance with the present disclosure;

FIG. 2 schematically illustrates an exemplary device including a battery pack including a plurality of battery cells, in accordance with the present disclosure;

FIG. 3 is a graph illustrating exemplary test results comparing capacity retention of a battery cell versus a number of charge/discharge cycles through which the battery cell is operated at 4.4 volts (V), with a plurality of different electrolyte compositions in accordance with the present disclosure; and FIG. 4 is a graph illustrating exemplary test results comparing capacity retention of a battery cell versus a number of charge/discharge cycles through which the battery cell is operated at 4.6V, with a plurality of different electrolyte compositions in accordance with the present disclosure.

### DETAILED DESCRIPTION

As required, detailed embodiments of the present disclosure are disclosed herein; however, it is to be understood that the disclosed embodiments are merely exemplary of the disclosure that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present disclosure.

Unless specifically stated from context, as used herein, the term “about” is understood as within a range of normal tolerance in the art, for example within 2 standard deviations of the mean. “About” can be understood as within 10%, 5%, 1%, 0.5%, 0.1%, 0.05%, or 0.01% of the stated value. “About” can alternatively be understood as implying the exact value stated. Unless otherwise clear from the context, the numerical values provided herein are modified by the term “about. ”

High-capacity and high-power lithium (Li)-and manganese (n)-rich layered oxides (LMR) cathode materials are useful for a lithium-ion energy storage system powering a battery electric vehicle. Such an energy storage system may be described as a high energy density battery. The battery cells may include a silicon-and/or graphite-containing anode and an LMR cathode.

A capacity and cycling tolerance of the battery cells may vary according to operating conditions. Battery cell performance may vary according to cathode and anode material selection. An electrolyte composition disclosed herein provides excellent cycle life for the battery cells. In one embodiment, the electrolyte composition includes a solvent and a partially substituted phosphite additive. The partially substituted phosphite additive is chosen from mono(trimethylsilyl) phosphite, bis(trimethylsilyl) phosphite, a Li salt derivative thereof, or a combination thereof. In one or more embodiments of the disclosure, the partially substituted phosphite additive is present in an amount of from about 0.1 to about 5 wt. %, based on a total weight of the electrolyte composition.

Testing has shown that addition of the partially substituted phosphite additive in the described weight percentages improves solid electrolyte interface (SEI) formation on the electrode(s), e.g., the LMR cathode, and forms an excellent preservation layer upon both the LMR cathode and the anode. An SEI may form upon a surface of the LMR cathode. An SEI results from a chemical reaction between the LMR cathode and a liquid or gel electrolyte interacting with the cathode. The SEI forms as a film upon the LMR cathode and has been found to improve the cycle life for the battery cell.

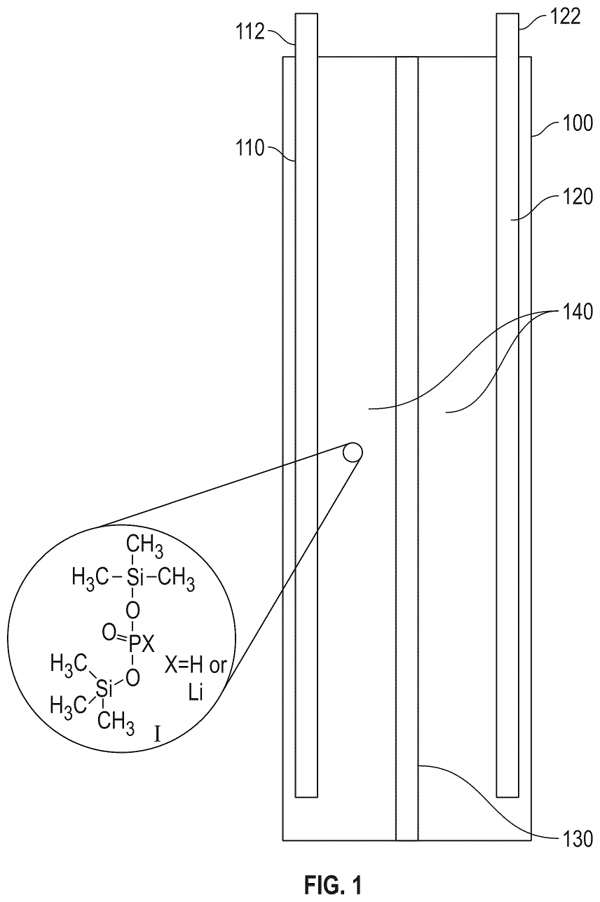

Referring now to the drawings, wherein like reference numbers refer to like features throughout the several views, FIG. 1 schematically illustrates an exemplary battery cell 100, including an anode 110, a cathode 120, a separator 130, and an electrolyte composition 140. The battery cell 100 enables converting electrical energy into stored chemical energy in a charging cycle, and the battery cell 100 enables converting stored chemical energy into electrical energy in a discharging cycle. A negative current collector 112 is illustrated connected to the anode 110, and a positive current collector 122 is illustrated connected to the cathode 120. The separator 130 is operable to separate the anode 110 from the cathode 120 and to enable ion transfer through the separator 130. The electrolyte composition 140 is a liquid or gel that provides a lithium-ion conduction path between the anode 110 and the cathode 120.

The anode 110 may be constructed of silicon, a silicon alloy, or other silicon-containing material (e.g., SiOx wherein x is a value greater than 0) and/or a graphite or graphite-containing material and/or lithium metal. The cathode 120 may be constructed of a lithium-and manganese-rich layered oxides (LMR) cathode active material. In one embodiment, the cathode 120 is a LMR cathode that includes a LMR cathode active material having the chemical formula of LiₓMn_{y}Ni_{z}O₂, wherein x is from 1.1 to 1.5, y is from 0.8 to 0.6, and z is from 0.2 to 0.4. The LMR cathode may further include other cathode active materials, such as, for example, LFMP (lithium iron manganese phosphate), LFP (lithium iron phosphate, e.g., LiFePO₄), NCMA (nickel manganese cobalt aluminum oxide), NMC (nickel manganese cobalt oxide), NCA (nickel cobalt aluminum oxide), and/or LNMO (e.g., spinel LiNi_{0.5}Mn_{1.5}O₄). In an exemplary embodiment, the LMR cathode includes or has about 92 wt. % or greater of cathode active material with the loading per unit area of from about 10 to about 30 mg/cm². In an exemplary embodiment, the anode 110 and the cathode 120 have a negative to positive (N/P) ratio of from about 1 to about 3.

In one or more embodiments of the disclosure, the electrolyte composition 140 includes a solvent and a partially substituted phosphite additive chosen from mono(trimethylsilyl) phosphite, bis(trimethylsilyl) phosphite (BTMSPi), a Li salt derivative thereof, or a combination thereof. As illustrated in FIG. 1, in an exemplary embodiment, the partially substituted phosphite additive has a chemical formula I, wherein when x=hydrogen (H), formula I defines the chemical structure for bis(trimethylsilyl) phosphite, and when x=lithium (Li), formula I defines the chemical structure for lithium bis(trimethylsilyl) phosphate, which is a Li salt derivative of bis(trimethylsilyl) phosphite. In an exemplary embodiment, the partially substituted phosphite additive is present in an amount of from about 0.1 to about 5 wt. %, such as, from about 1 to about 5 wt. %, such as, from about 2 to about 4 wt. %, for example, about 3 wt. %, based on a total weight of the electrolyte composition 140.

The electrolyte composition 140 may further include other co-additives. Non-limiting examples of various co-additives include one or more lithium-based compounds and/or one or more phosphorous-and silicon-based additives. Non-limiting examples of lithium-based compounds include LiPO₂F₂ (lithium difluorophosphate), LiTFSI (lithium bis(trifluoromethane)sulfonimide), LiFSI (lithium bis(fluorosulfonyl)imide), LiDFOB (lithium difluoro(oxalato)borate), and/or LiBOB (lithium bis(oxalato)borate). In an exemplary embodiment, the one or more lithium-based compounds is present in an amount of from about 0.1 to about 2 wt. %, based on a total weight of the electrolyte composition 140. Non-limiting examples of phosphorus-and silicon-based additives include tris(trimethylsilyl) phosphite and/or tris(trimethylsilyl) phosphate. In an exemplary embodiment, the one or more phosphorous-and silicon-based additives is present in an amount of from about 0.1 to about 2 wt. %, based on a total weight of the electrolyte composition 140.

Non-limiting examples of the solvent in the electrolyte composition 140 include fluoroethylene carbonate, dimethyl carbonate, ethylene carbonate, ethyl methyl carbonate, dimethyl carbonate, propylene carbonate, 2,2,2-trifluoroethyl methyl carbonate, bis(2,2,2-trifluoroethyl) carbonate, and/or 3,3,3-trifluoropropylene carbonate. In one example, the solvent includes a cyclic carbonate, for example ethylene carbonate (EC), and linear carbonate, for example dimethyl carbonate.

In an exemplary embodiment, the battery cell 100 is configured to operate over a voltage window of from about 2.0 to about 5.0 V. In an exemplary embodiment, the battery cell 100 is configured to be charged at a charging rate of from about C/100 to about 6 C.

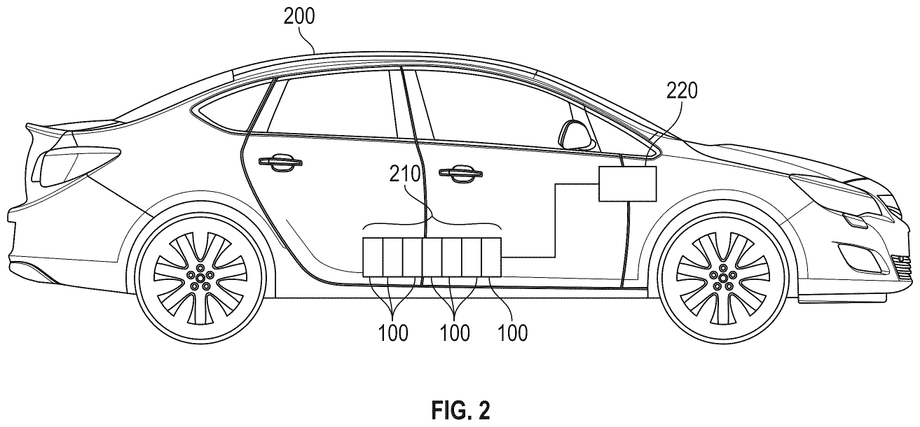

The battery cell 100 may be utilized in a wide range of applications and powertrains. FIG. 2 schematically illustrates an exemplary device 200, e.g., a battery electric vehicle (BEV), including a battery pack 210 that includes a plurality of battery cells 100. The plurality of battery cells 100 may be connected in various combinations, for example, with a portion being connected in parallel and a portion being connected in series, to achieve goals of supplying electrical energy at a desired voltage. The battery pack 210 is illustrated as electrically connected to a motor generator unit 220 useful to provide motive force to the vehicle 200. The motor generator unit 220 may include an output component, for example, an output shaft, which is provided mechanical energy useful to provide the motive force to the vehicle 200. A number of variations to vehicle 200 are envisioned, and the disclosure is not intended to be limited to the examples provided.

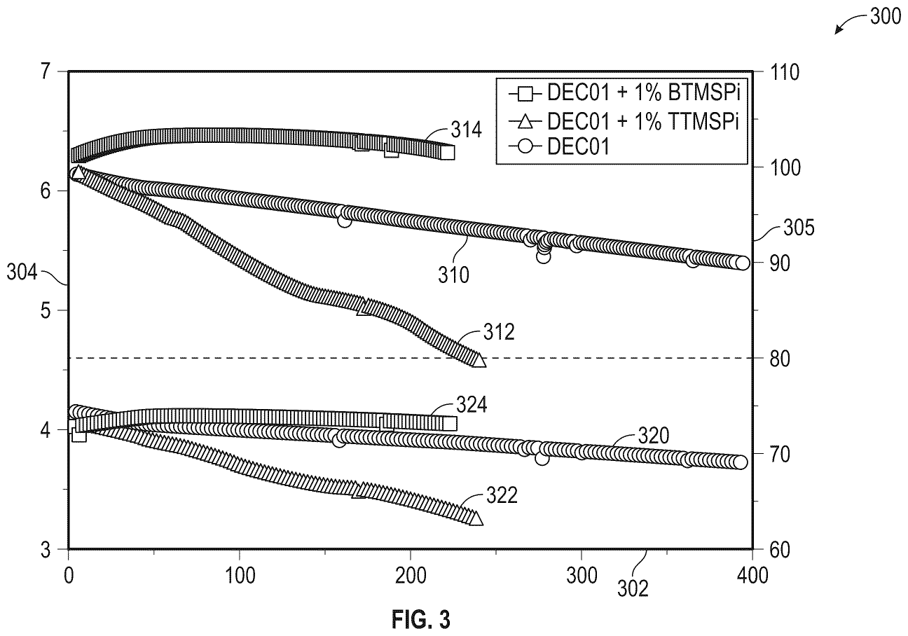

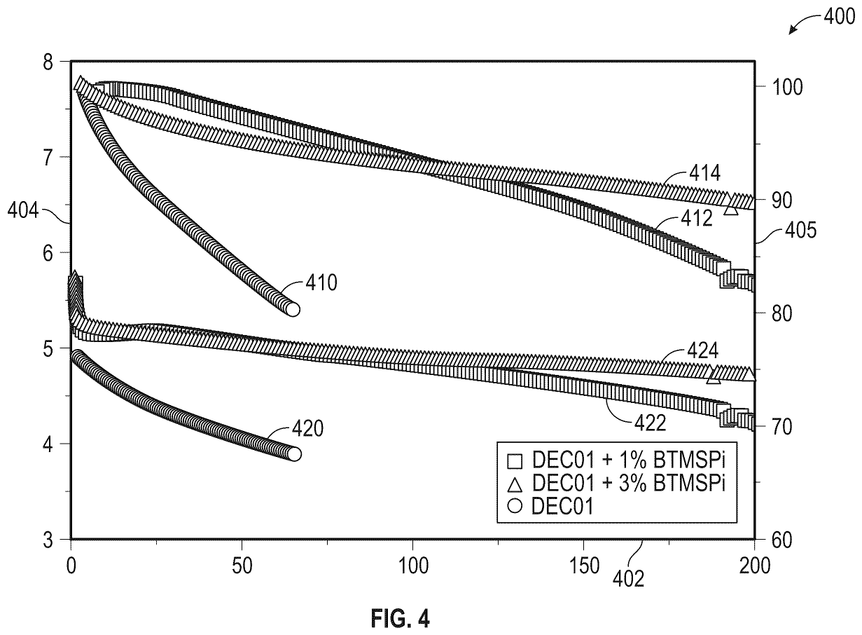

FIG. 3 is a graph 300 illustrating exemplary test results of a relationship between discharge capacity retention of a battery cell and a number of charge/discharge cycles through which the battery cell is operated. A vertical axis 304 is illustrated describing discharge capacity in units of mAh/cm², and vertical axis 305 is illustrated describing discharge capacity retention in percentage (%). A horizontal axis 302 is illustrated describing the number of charge/discharge cycles. As illustrated, line 310 represents the baseline electrolyte composition, line 312 represents the baseline electrolyte composition modified with 1% TTMSPi, and line 314 represents the baseline electrolyte composition modified with 1% BTMSPi, all at the higher initial discharge capacity. Likewise, line 320 represents the baseline electrolyte composition, line 322 represents the baseline electrolyte composition modified with 1% TTMSPi, and line 324 represents the baseline electrolyte composition modified with 1% BTMSPi, all at the lower initial discharge capacity. As indicated in the graph 300, upon cycling at 4.4 V upper cutoff voltage, bisphosphite additive (BTMSPi) containing electrolyte shows a superior cycle life performance than baseline or conventional trimethylsilyl phosphite additive (TTMSPi) systems.

FIG. 4 is a graph 400 illustrating exemplary test results of a relationship between capacity retention of a battery cell and a number of charge/discharge cycles through which the battery cell is operated. A vertical axis 404 is illustrated describing discharge capacity in units of mAh/cm², and vertical axis 405 is illustrated describing discharge capacity retention in percentage (%). A horizontal axis 402 is illustrated describing the number of charge/discharge cycles. As illustrated, line 410 represents the baseline electrolyte composition, line 412 represents the baseline electrolyte composition modified with 1% BTMSPi, and line 414 represents the baseline electrolyte composition modified with 3% BTMSPi, all at the higher initial discharge capacity. Likewise, line 420 represents the baseline electrolyte composition, line 422 represents the baseline electrolyte composition modified with 1% BTMSPi, and line 424 represents the baseline electrolyte composition modified with 3% BTMSPi, all at the lower initial discharge capacity. As indicated in the graph 400, cycling at even the higher cutoff voltage, 4.6 V, the bisphosphite additive (BTMSPi) shows far superior cycle life performance than baseline electrolyte (without any additive). Additionally, the performance at high voltage is dependent on the actual concentration of the bisphosphite additive (BTMSPi). Increasing the concentration from 1% to 3%, significantly improves the cycle performance at 4.6 V.

While the best modes for carrying out the disclosure have been described in detail, those familiar with the art to which this disclosure relates will recognize various alternative designs and embodiments for practicing the disclosure within the scope of the appended claims.

What is claimed is:

1. An electrolyte composition for batteries, the electrolyte composition comprising:
a solvent; and
a partially substituted phosphite additive chosen from mono(trimethylsilyl) phosphite, bis(trimethylsilyl) phosphite, a Li salt derivative thereof, or a combination thereof.

2. The electrolyte composition of claim 1, wherein the Li salt derivative thereof is lithium bis(trimethylsilyl) phosphate.

3. The electrolyte composition of claim 1, wherein the partially substituted phosphite additive is bis(trimethylsilyl) phosphite.

4. The electrolyte composition of claim 1, wherein the partially substituted phosphite additive is present in an amount of from about 0.1 to about 5 wt. %, based on a total weight of the electrolyte composition.

5. The electrolyte composition of claim 1, wherein the partially substituted phosphite additive is present in an amount of from about 1 to about 5 wt. %, based on a total weight of the electrolyte composition.

6. The electrolyte composition of claim 1, wherein the partially substituted phosphite additive is present in an amount of from about 2 to about 4 wt. %, based on a total weight of the electrolyte composition.

7. The electrolyte composition of claim 1, further comprising co-additives.

8. The electrolyte composition of claim 7, wherein the co-additives include one or more lithium-based compounds chosen from LiPO₂F₂, LiTFSI, LiFSI, LiDFOB, LiBOB. or a combination thereof.

9. The electrolyte composition of claim 8, wherein the one or more lithium-based compounds is present in an amount of from about 0.1 to about 2 wt. %, based on a total weight of the electrolyte composition.

10. The electrolyte composition of claim 7, wherein the co-additives includes one or more phosphorous- and silicon-based additives chosen from tris(trimethylsilyl) phosphite, tris(trimethylsilyl) phosphate, or a combination thereof.

11. The electrolyte composition of claim 10, wherein the one or more phosphorous-and silicon-based additives is present in an amount of from about 0.1 to about 2 wt. %, based on a total weight of the electrolyte composition.

12. The electrolyte composition of claim 10, wherein the solvent is chosen from fluoroethylene carbonate, dimethyl carbonate, ethylene carbonate, ethyl methyl carbonate, dimethyl carbonate, propylene carbonate, 2,2,2-trifluoroethyl methyl carbonate, bis(2,2,2-trifluoroethyl) carbonate, 3,3,3-trifluoropropylene carbonate, or a combination thereof.

13. A battery comprising:
an anode;
a lithium-and manganese-rich layered oxides (LMR) cathode; and
an electrolyte composition disposed between the anode and the LMR cathode, the electrolyte composition comprising:
a solvent; and
a partially substituted phosphite additive chosen from mono(trimethylsilyl) phosphite, bis(trimethylsilyl) phosphite, a Li salt derivative thereof, or a combination thereof.

14. The battery of claim 13, wherein the LMR cathode comprises LixMnyNiZO₂, wherein x is from 1.1 to 1.5, y is from 0.8 to 0.6, and z is from 0.2 to 0.4.

15. The battery of claim 14, wherein the LMR cathode further comprises LFMP, LFP, NCMA, NMC, NCA, LNMO, or a combination thereof.

16. The battery of claim 13, wherein the anode comprises SiOx/graphite, graphite, Si, SiOx, lithium metal, or a combination thereof, and wherein x is a value greater than 0.

17. The battery of claim 13, wherein the anode and the LMR cathode have a negative to positive (N/P) ratio of from about 1 to about 3.

18. The battery of claim 13, wherein the battery is configured to operate over a voltage window of from about 2.0 to about 5.0 V.

19. The battery of claim 13, wherein the battery is configured to be charged at a charging rate of from about C/100 to about 6 C.

20. A device comprising:
an output component: and a battery configured for providing electrical energy to the output component, wherein the battery comprises:
an anode;
a lithium-and manganese-rich layered oxides (LMR) cathode; and
an electrolyte composition disposed between the anode and the LMR cathode, wherein the electrolyte composition comprises:
a solvent, wherein the solvent is chosen from fluoroethylene carbonate, dimethyl carbonate, ethylene carbonate, ethyl methyl carbonate, dimethyl carbonate, propylene carbonate, 2,2,2-trifluoroethyl methyl carbonate, bis(2,2,2-trifluoroethyl) carbonate, 3,3,3-trifluoropropylene carbonate, or a combination thereof; and
a partially substituted phosphite additive chosen from mono(trimethylsilyl) phosphite, bis(trimethylsilyl) phosphite, a Li salt derivative thereof, or a combination thereof, wherein the partially substituted phosphite additive is present in an amount of from about 0.1 to about 5 wt. %, based on a total weight of the electrolyte composition.
